(19) United States
(12) Patent Application Publication
(10) Pub. No.: US 2012/0002310 A1
(43) Pub. Date: Jan. 5, 2012

(54) ROTATING MIRROR HOLDER FOR VEHICLE MIRROR, IN PARTICULAR FOR UTILITY VEHICLES, AND A MIRROR ARRANGEMENT HAVING SAID MIRROR HOLDER

(76) Inventors: Willi Felbinger, Markt Nordheim (DE); Mirjam Lucht, Burgbernheim (DE)

(21) Appl. No.: 13/256,901

(22) PCT Filed: Mar. 17, 2010
(86) PCT No.: PCT/EP10/53474

§ 371 Date: Sep. 15, 2011

(30) Foreign Application Priority Data
Mar. 17, 2009 (DE) 10 2009 013 645.2

(51) Int. Cl. B60R 1/02; G02B 7/198

(52) U.S. Cl. 359/872

(57) ABSTRACT

The invention relates to a mirror holder (4, 6) for a vehicle mirror (8) having a first and a second connection component (10, 12) that are connected around a rotation axis (A) to one another in a rotating manner, wherein the first connection component (10) has a bolt (14) comprising a mantel surface (18) that is rotation-symmetrical with regard to the rotation axis (A), the second connection component (12) has a sleeve (16) enclosing the bolt (14) having an inner mantel surface (24) that is formed in a manner complementary to the rotation-symmetrical mantel surface (18) and bolt (14) or sleeve (16) has at least one engagement element (20) that engages in a holder element (22) that is formed in a complementary manner in the sleeve (16) or bolt (14) and blocks a shifting of the two connection components (10, 12) in the direction of the rotation axis (A).

The present invention relates to a rotatable mirror holder for automotive vehicle mirrors, in particular for utility vehicles, and a mirror assembly having said mirror holder.

Conventional mirror holders are usually made up of two component parts, namely, a vehicle-side holder which is adapted to be connected to the vehicle, and a mirror-side holder which establishes the connection to the respective mirrors. Both connection components have corresponding connection surfaces at which they are connected to each other. In accordance with the prior art, the connection components are mostly connected by a threaded connection while partly also being secured with the aid of a so-called quick-lock. The axis of the threaded connection at the same time defines the rotation axis of the two parts. In order to secure the most constant frictional force possible, a disk spring is generally underlain, or a compression spring for further reducing the tolerance influences.

Owing to the multiplicity of the components required for this purpose, such as bolt, nut, disk springs etc., not only the manufacture but also the assembly of such a mirror holder is complex and expensive. The demands to a constant frictional force as well as the demand for a stable and thus low-vibration mirror holder results in a demand for low tolerances of all components involved and an assembling process in which the manufacturing parameters are continuously adapted to the variations by way of controls. This causes the manufacturing costs to rise. Moreover, a greater number of single parts generally brings about higher logistical expenditure, e.g. with regard to stocking.

It is therefore an object of the present invention to furnish a mirror holder for an automotive vehicle mirror which may on the one hand be produced at minimum expenditure and low cost, and on the other hand provides a stable and lasting functional rotary connection between vehicle and mirror.

With regard to the holder, this object is achieved through the features of claim 1, and with regard to the mirror assembly through the features of claim 18.

In the mirror holder of the invention, the first connection component comprises a bolt having a rotationally symmetrical jacket surface. The second connection component comprises a sleeve encircling the bolt and having an inner jacket surface formed complementarily with the jacket surface of the bolt, wherein one of the bolt and the sleeve comprises at least one engagement element which is engaged in a complementarily shaped retaining member in the sleeve or the bolt, thus blocking a displacement of the two connection components in the direction of the rotation axis.

Due to he interlocking relation of engagement element and retaining member, the two connection components are connected to each other with form-fit and only admit a rotation about the rotation axis. On the one hand, the bolt is fixed radially and centered in the sleeve, and on the other hand the bolt is fixed axially in the sleeve. This form-fit moreover does away with the necessity of a threaded connection etc. for fixation of the two connection components, so that material and assembling costs may be saved and the overall costs of the mirror holder may be reduced. Faulty assembly can moreover not occur any more due to the omission of an assembling process.

In a preferred manner, sleeve and bolt comprise complementarily shaped first and second locking surfaces. The provision of locking surfaces on the one hand allows to define certain relative angles between the two connection components, while on the other hand this may be utilized to set a certain threshold value for the fold-in force of the mirror. While the fold-in force must be high enough for the mirror to resist external forces during normal usage, such as wind resistance, it must nevertheless be adjustable by the driver or allow the mirror to yield under extraordinary force influences for safety reasons.

In accordance with claim 3, the two locking surfaces are formed on the jacket surfaces of bolt and sleeve. This allows an adjustment of the rotational resistance by way of the wall thickness of the sleeve. If the wall thickness of the sleeve is low, the latter yields in a radial outside direction when the bolt is rotated. Apart from this, the locking force is determined by the shape of the locking mechanism having the form of a flattening, shaft etc., and by the locking depth.

In accordance with claim 4, the two locking surfaces are provided on the end face of the bolt and on the bottom inside the sleeve. As the axial displacement of the two connection components is blocked by engagement element and holding member, the end faces of the bolt and the sleeve bottom are biased relative to each other, as it were, so that the locking surfaces engage each other. At a corresponding configuration of engagement element and holding member it is possible to establish a locking function involving a lower locking force as compared with the previous variant.

If the rotation axis is formed transversely to the longitudinal axis from the first and/or second connection component, the mirror holder of the invention represents a hinge joint. The mirror holder of the invention thus allows not only a rotation of two connection components on a rotation axis but also a pivotal movement of one connection component about this rotation axis. The mirror holder of the invention thus represents a flexible connection and is not limited to any screw axes of threaded connections.

In a preferred manner, the sleeve is an injection-molded part of a first plastic material. This aspect provides a number of advantages. For one thing, the entire mirror holder may be produced in a very simple manner by injection coating of the second connection component on the first connection component. Injection coating of the plastic material at the same time achieves a connection between sleeve and bolt that is virtually free of play. Shrinkage of the sleeve during curing of the plastic material even produces a radial force acting on the bolt, so that the radial force of the sleeve acting on the bolt, i.e., the fold-in force of the mirror, may even be adjusted through selection of the plastic material.

In selecting the plastic material it is necessary to preclude the connection components adapted for relative pivoting from being bonded or fused during injection molding. As the sleeve is injection-coated on the jacket surface of the bolt and complementarily adapts the shape of the inner jacket surface of the sleeve to the jacket surface of the bolt, manufacturing inaccuracies during manufacture of the bolt do not have any effects on the functionality of the rotary connection. Such inaccuracies are simply compensated by injection molding. This adaptation also allows to obtain a very low-vibration mirror holder.

As mirror holders are manufactured at high piece numbers, this manufacturing method results in enormous cost savings which outweigh the manufacture of the injection molding tool by far. Injection molding of the sleeve always allows to produce a complementary jacket surface of the sleeve even for bolt jacket surfaces having a complex shape, so that the form-fit of the mirror holder will lastly already be defined through the configuration of the bolt.

Due to injection molding of the sleeve a non-releasable connection between first and second connection components is achieved, whereby a stable and permanently connected rotary connection between two connection components is obtained which does not require maintenance throughout its entire service life.

In a preferred manner not only the sleeve but also the bolt is an injection-molded part, which then consists of a second plastic material having a higher melting point than the first plastic material. The mirror holder may be produced by the so-called in-mold assembly process. In this case a first connection component is produced in the basic process type. This may be either a plastic material component or a die-cast component or some other component. In a second process step this first connection component is inserted in the tool for the manufacture of the second connection component, with the sleeve encircling the bolt on account of the advantageous realization by the manufacturing process. If the first component is also realized of plastic material, this allows to manufacture the mirror holder in a single manufacturing process including single process steps, whereby the manufacturing costs may be reduced further. The two plastic material types should be selected such that the plastic bolt will not be melted when the sleeve is injection-molded on it. Moreover it is possible to adjust the relative frictional and/or locking forces of the two connection components via the combination of the two kinds of plastic material.

In order to ensure mobility of the two connection components, it is necessary to make sure that during the manufacture of the second connection component the plastic material thereof does not enter a surface connection with the material of the first connection component. To this end it is necessary for the melting temperature of the first material to be higher than the temperature of the second material at the time when the second material contacts the first material. If the manufacturing parameters are selected appropriately, it is possible to produce both parts of a same material. It is, however, particularly advantageous if the two materials are of a different kind while having only a very low tendency, even in the plastic condition, to melt together, wherein the material of the first connection component should have a higher temperature stability.

Mobility of the two connection components may also be achieved by selecting two kinds of plastic material that are not compatible with each other and do not adhere to each other. This allows nearly simultaneous injection molding of the two connection components.

Advantageously, the retaining member is a continuous groove in the jacket surface of bolt or sleeve. Such an annular groove may be produced in a very simple manner and allows on the one hand a rotary movement of the complementary connection component about the rotation axis while on the other hand preventing a relative displacement of the two parts in the direction of the rotation axis. This groove forms an undercut.

Advantageously, the engagement element is a—preferably also continuous—protrusion which is engaged in the groove. Engagement element and retaining member thus establish a form-fit in the direction of the rotation axis.

If the first and second locking surfaces are provided in the groove or on the protrusion, respectively, it is possible to produce both the axial fixation and the immobilization of the two connection components in the peripheral direction in one production step.

Configuring the bolt in the shape of a partial sphere is equally simple and effective. Just like the combination of groove and protrusion, this allows to obtain a form-fit that securely prevents a displacement of the connection components and admits the free rotary movement. Where the sleeve covers the part of the spherical shape exclusively, this advantageous configuration allows to obtain a wide degree of freedom insofar as the second connection component can be moved not only about the rotation axis relative to the first connection component but also in a small angular range about the sphere's center. As a result, a flexible utilization of the same mirror holder at different positions of the mirror head and of the rotation axis of the mirror system is possible.

As was already mentioned in the foregoing, the mirror holder of the invention may be produced in a very simple way by an in-mold assembly process. Here, the first injection-molded part is produced in a first mold and subsequently introduced into a second mold and injection coated by the second injection molding material. Optionally, the first injection-molded part remains in the first mold, with merely another cavity having the shape of the second injection-molded part being released. The first injection-molded part represents, as it were, the insert for the second injection-molded part. This is also referred to as a so-called pre-molded part. In this way it is possible to obtain a variety of tightly fitting connection surfaces of the two connection components which admit a relative movement of the two connection components while, however, preventing an axial displacement.

The two connection components of the mirror holder of the invention are preferably connected to each other in a non-releasable manner so that the connection can not become loose by itself.

Advantageously, the bolt and the sleeve are each formed integrally, whereby the number of connection components is reduced to a minimum.

The subject matter of claim 20 is a mirror assembly comprising at least one mirror holder in accordance with one of the aspects mentioned in the foregoing.

### SHORT DESCRIPTION OF THE FIGURES

FIG. 1 shows a mirror assembly comprising a mirror housing and two mirror holders in accordance with a first embodiment of the invention;

FIG. 2 is a cross-sectional view along line II-II shown in FIG. 1;

FIG. 3 is a cross-sectional view along line III-III shown in FIG. 2;

FIG. 4 shows a mirror holder in accordance with a second embodiment;

FIGS. 5A to 5F show longitudinal sectional views along line V-V shown in FIG. 4 with different shapes of retaining and engagement members;

FIG. 6 shows a first connection component with locking surfaces on a jacket surface of the bolt portion in accordance with a third embodiment;

FIG. 7 shows a first connection component with locking surfaces in a continuous annular groove in a bolt portion in accordance with a fourth embodiment;

FIGS. 8A to 8E show cross-sectional views along line VIII-VIII in FIG. 6;

FIG. 9 shows a mirror holder in accordance with a fifth embodiment;

FIG. 10 is a drawn-apart view of FIG. 2a;

FIG. 11 is a detail view of the mirror base shown in FIG. 9;

FIG. 12 shows the mirror base of FIG. 9 in accordance with a sixth embodiment;

FIG. 13 shows a mirror holder in accordance with a seventh embodiment;

FIG. 14 is a drawn-apart view of FIG. 13;

FIG. 15 shows a mirror holder in accordance with an eighth embodiment;

FIG. 16 is a drawn-apart view of FIG. 15; and

FIG. 17 shows a mirror holder in accordance with a ninth embodiment.

### DETAILED DESCRIPTION OF THE EMBODIMENTS

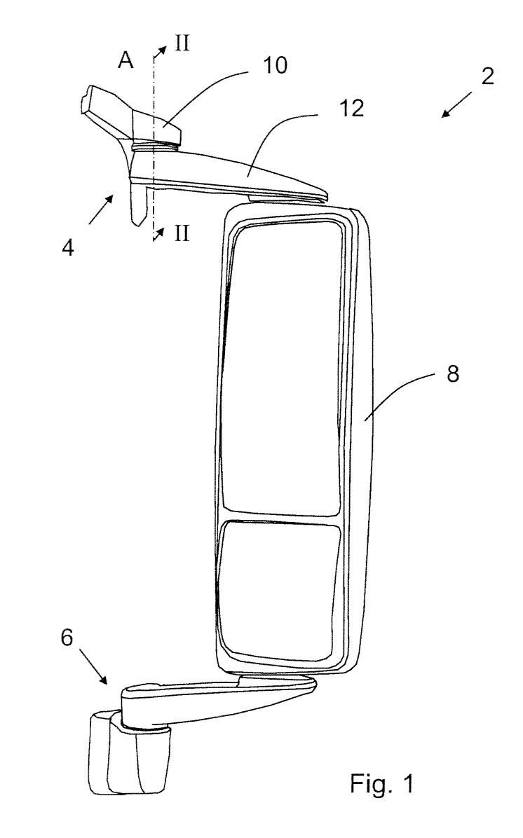

FIG. 1 shows a mirror assembly 2 comprising an upper mirror holder 4 and a lower mirror holder 6 receiving a mirror housing 8 between them, optionally in a rotatable manner. The mirror holder 4 consists of a vehicle-side holder 10 as a first connection component and a mirror-side holder 12 as a second connection component, which are adapted to be rotated relative to each other about a rotation axis A. This rotation axis A likewise extends through the lower mirror holder 6 and thus allows to pivot the entire mirror together with the mirror head relative to the vehicle. In the mirror housing 8, in turn, adjustably mounted mirror glasses are provided. The vehicle-side holder 10 comprises corresponding fastening surfaces for fastening to the vehicle. On the other side, the mirror-side holder 12 allows corresponding coupling to the respective mirror housing 8. In this embodiment, the mirror housing 8 is attached on both sides to mirror arms formed by the mirror-side holders 12.

The mirror assembly 2 shown in FIG. 1 comprises two mirror holders 4 and 6. In the following description, only the upper mirror holder 4 shall be described by way of example, wherein only the upper mirror holder 4, only the lower mirror holder 6, or both mirror holders 4 and 6 may optionally have the structure described below.

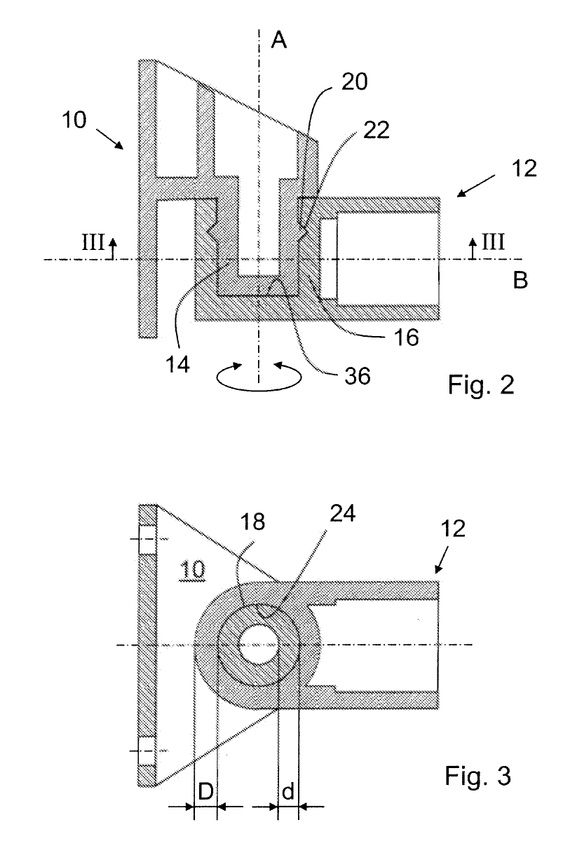

FIG. 2 shows a cross-sectional view of the upper mirror holder 4 comprising a first connection component 10 which is adapted to be connected to the vehicle, and a second connection component 12 which is adapted to be connected to the mirror housing 8. The first connection component 10 comprises a bolt 14 which is encircled by a sleeve 16 of the second connection component 12. The bolt 14 has on its outer jacket surface 18 a rotationally symmetrical, continuous projection 20 engaged in an annular groove 22 which has a correspondingly complementary shape and is formed inside an inner jacket surface 24 of the sleeve 16. In this manner, the two connection components 10 and 12 may be rotated relative to each other about the rotation axis A, however can not be displaced along the rotation axis A. The two connection components 10 and 12 thus have relative mobility on the one hand while, on the other hand, being connected to each other in a non-releasable manner.

This rotary connection may be produced in a very simple manner by the so-called in-mold assembly process, also in a single injection molding tool, wherein the individual injection-molded parts need not be assembled with each other but are cured inside each other. Alternatively, the connection component 10 comprising the bolt 14 may also be made of any other material, also of metal, onto which a plastic material is injection-coated in order to realize the sleeve 16. In the selection of the materials used care should be taken, however, that these will not connect or adhere to each other in the manufacturing process, so as to achieve the desired rotary mobility of the two connection components relative to each other. In the manufacture of the two connection components it is therefore advisable to only use plastic material types that are not compatible with each other. The rotary mobility may in particular be obtained in that the connection component comprising the bolt and injection-molded first consists of a plastic material having a higher melting point than the second connection component which is molded onto the first connection component in a subsequent step.

On account of injection coating of the one connection component onto the other one, the tolerance of the components with regard to their size is insignificant, for the sleeve in the second connection component inevitably assumes the size of the bolt of the first connection component. A play-free connection at high fitting quality that satisfies highest requirements to the vibrational comportment is thus achieved without any undue process requirements.

As the injection-coated sleeve 16 closely follows the jacket surface 18 of the bolt 14 and undergoes some shrinkage during curing, a radial force from the sleeve 16 onto the bolt 14 is generated, so that a certain rotating force is necessary for rotating the two connection components 10 and 12 relative to each other. This frictional force between bolt 14 and sleeve 16 thus defines a fold-in force which is created as early as during the manufacturing process of the mirror holder and on the one hand withstands usual external forces, such as wind resistance, while on the other hand—if so desired—admitting a relative rotation of the two connection components. This fold-in force may be adjusted through selection of the different material combinations.

Another parameter for the adjustment of the rotational mobility of the two connection components 10 and 12 is represented by the wall thickness D of the sleeve 16. As a more or less rigid construction is obtained depending on the wall thickness, the frictional forces between sleeve 16 and bolt 14 thus increase or decrease accordingly. Moreover the bolt portion 14, as shown in FIGS. 2 and 3, may also present a hollow profile so that the frictional forces between bolt 14 and sleeve 16 may also be adjusted by means of the wall thickness d of the bolt 14.

Other than in the representation of FIGS. 2 and 3, the mirror-side holder 12 may moreover comprise a bolt which engages in a sleeve of a vehicle-side holder.

While FIGS. 1 to 3 showed a mirror holder of the invention in which the longitudinal axis B of a connection component, namely, the mirror-side holder 12, is formed perpendicularly to the rotation axis A and forms, as it were, a hinge joint or a pivotable mirror holder, a second embodiment will be described in the following where the longitudinal axes of the two connection components are situated on the rotation axis. From this it may be seen that the mirror holder of the invention allows for a variety of rotary connections without any added complexity in terms of construction.

As was already mentioned, FIG. 4 shows a mirror holder 4 consisting of a vehicle-side holder 10 and a mirror-side holder 12. The two connection components 10 and 12 may be rotated relative to each other with respect to a common longitudinal axis A. Such a mirror holder wherein the mirror housing need not be pivoted but is only intended for rotation about the axis of the mirror holder may be utilized, e.g., in so-called ramp or front mirrors on utility vehicles.

Similarly to the first embodiment, the mirror-side connection component 12 comprises a sleeve 16 which encircles a bolt 14 of the vehicle-side connection component 10. An end portion of the vehicle-side connection component 10 includes a fastening portion 26 which may be clamped fast in different rotary positions about the screw axis on a corresponding counterpart on the vehicle via a threaded connection. The mirror-side connection component 12 includes a bore 28 for coupling of the mirror housing.

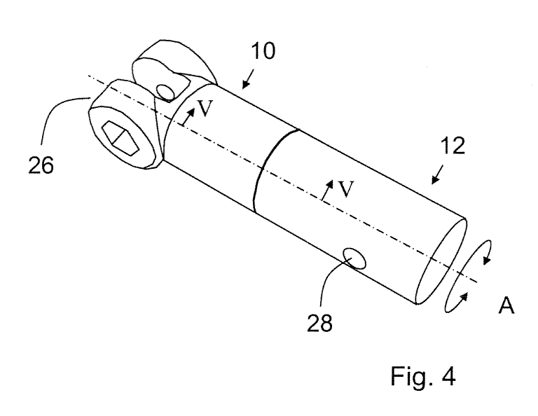

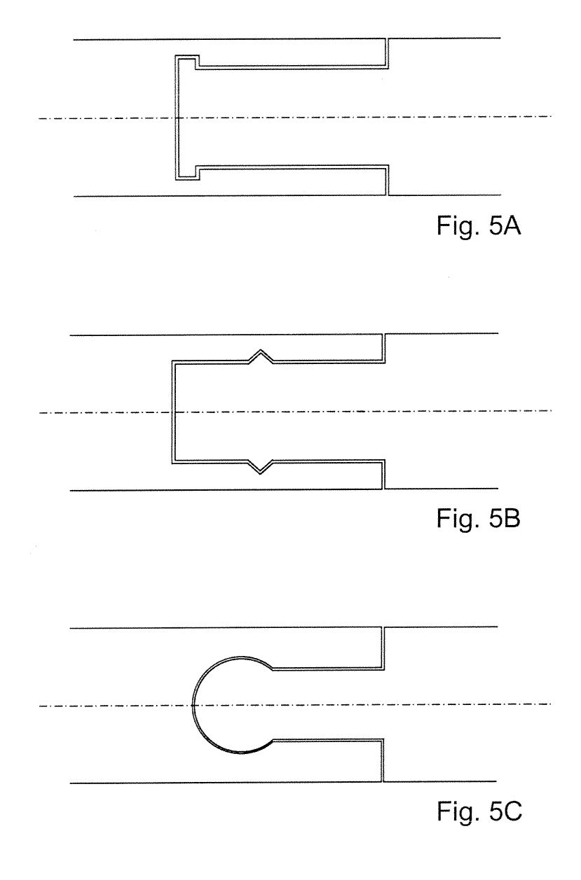

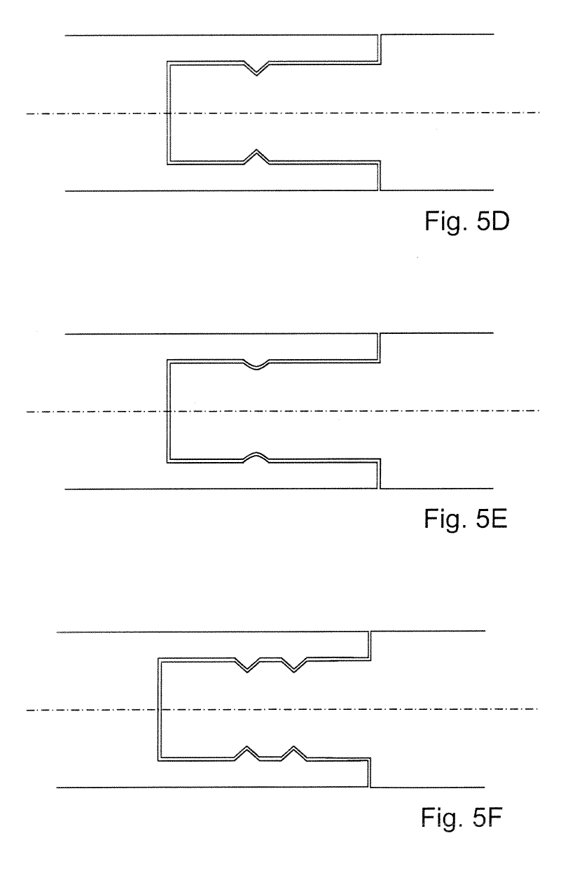

Axial fixation of the two connection components 10 and 12 may be realized in various manners, as is shown by way of example in FIGS. 5A to 5F. FIGS. 5A to 5F schematically show longitudinal sections along line V-V of FIG. 4. In FIGS. 5A to 5C the bolt 14 comprises different engagement elements 20 having the form of a flange (FIG. 5A), a continuous projection (FIG. 5B), and a sphere (FIG. 5C) that are engaged in corresponding recesses of the sleeve 16, whereas in FIGS. 5D to 5F the engagement elements are formed on the inner jacket surface of the sleeve 16 and are engaged in corresponding complementary recesses in the jacket surface 18 of the bolt 14. According to FIG. 5D, a plurality of engagement elements may also cooperate with corresponding retaining members. In addition to the variants shown in FIG. 5A to 5F, additional configurations are conceivable, of course. All variants have in common, however, that they comprise a rotationally symmetrical and uninterrupted jacket surface so as to allow a rotary movement of the two connection components relative to each other.

It should be noted that for reasons of clarity, the connections of bolt 14 and sleeve 16 in FIGS. 5A to 5F are represented with a large play which does, of course, not exist in the mirror holder of the invention, for the sleeve 16 is injection-molded around the bolt 14 so as to adapt to and closely follow the outer contour of the bolt. The sleeve 16 not only contacts the bolt in a tight fit, but owing to shrinkage processes applies a radial force on the bolt, so that a certain force-fit between two connection components is generated solely during the manufacturing process of the mirror holder of the invention. This force-fit between bolt 14 and sleeve 16 is desired because the mirror should not be mounted in a freely movable manner. In order to increase this force that is required for rotating the two connection components 10 and 12, it is possible to take further measures which shall be described while making reference to the following third embodiment.

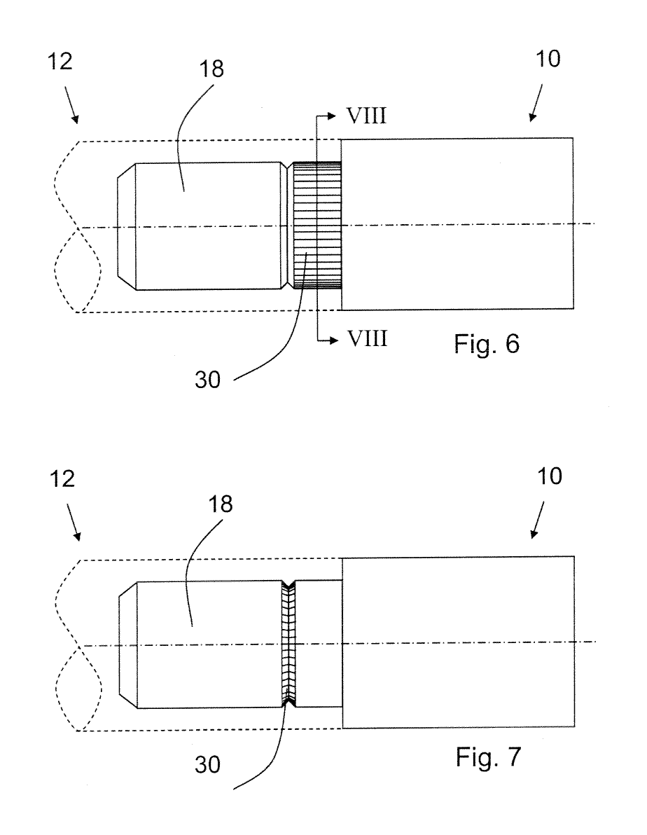

FIG. 6 shows a connection component 10 comprising not only an annular groove 22 on the jacket surface 18 of the bolt 14 but also locking surfaces 30. As is shown in FIG. 6, these locking surfaces 30 may be provided only on a certain portion of the jacket surface 18 or on the entire jacket surface 18. Alternatively, as is shown in FIG. 7, the retaining member 22 may also present the locking surfaces 30. Due to the provision of such locking surfaces 30, the previously mentioned requirement of a rotationally symmetrical jacket surface, which is fundamentally necessary for the rotational mobility of the connection components 10 and 12 among each other, is not satisfied. If, however, a polygon-type geometry or a denticulation with only a low effective slope angle and only very low deviations from the circular shape is used, it is still possible to rotate the two connection components 10 and 12 relative to each other by the application of a certain torque. The provision of such locking surfaces provides not only the possibility of increasing the fold-in force of the mirror holder but also adjustability of the two mirror holder components at predetermined relative angles between each other.

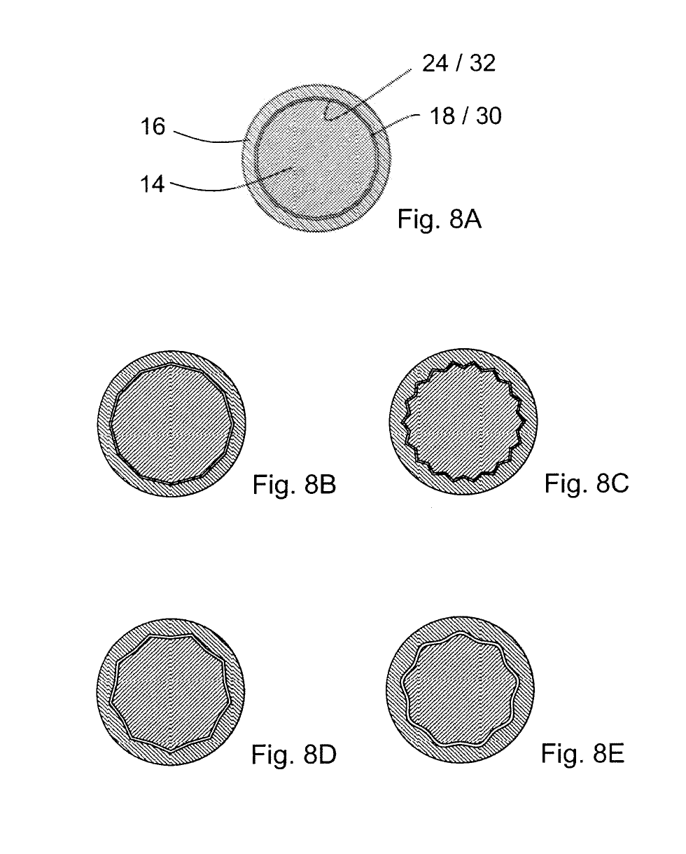

In FIGS. 8A to 8E different variants of such locking surfaces 30 having correspondingly complementary locking surfaces 32 on the inner jacket surface 24 of the sleeve 14 are shown in a cross-sectional view along line VIII-VIII in FIG. 6. The locking surfaces may have a tooth- or wave-type shape. The more the jacket surfaces 18 and 24 vary from the circle shape, the higher the torque will be that is required for rotating the sleeve 16 relative to the bolt 14. If the sleeve 16 is an injection-molded part of plastic material injection-coated onto the bolt 14, it is very easily possible to produce an inner jacket surface 24 of the sleeve 16 that is complementary to the jacket surface 18 of the bolt 14. The locking or frictional forces between sleeve 16 and bolt 14 may be adjusted not only through the selection of the geometry of the locking surfaces but also through the selection of the materials and wall thicknesses used. If the sleeve at any rate already applies a certain radial force to the bolt after the manufacturing process, very flat angles (relative to the circle line) of the locking surfaces are already sufficient for generating high locking forces, so that sufficient stability and abrasion resistance of the connection components may also be guaranteed throughout their lifetime.

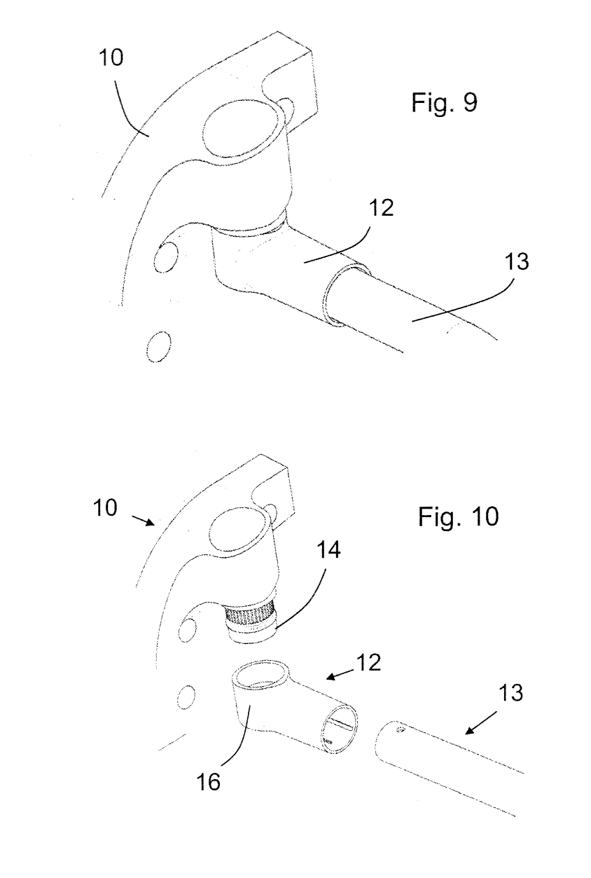

A traditional carrier for a utility vehicle mirror is formed of a metal pipe. Coupling to the connection member takes place inside a pipe sleeve. The usual pipe configuration assumes the shape of a “U”, with an upper and a lower arm thus representing the coupling to the mirror holder and the center part of the “U” extending in a rough approximation in parallel with the rotation axis. As a result, the longitudinal axis B is formed as a center axis of the pipe end in the pipe sleeve of the first or second connection component, transversely to the rotation axis. This allows on the one hand to revert to time-honored concepts, but on the other hand it is also possible to realize solutions for smaller numbers of pieces, for the tool costs for the individual components for each realization may be kept lower compared with a case in which the entire support structure consists of a “design” component to be specifically produced for the realization. The corresponding solution is shown by FIG. 9, with the mirror arm now consisting of two parts and being formed of a pipe sleeve 12 as a second connection component and a support pipe 13.

The realization including a locking sleeve 12 and a support pipe 13 further improves the flexibility of use of this inventive holder. The random rotational position of the support pipe inside the pipe sleeve by rotation about the longitudinal axis B allows for different positions of the support pipe and thus of the mirror head relative to the rotation axis A in the utilization of the identical mirror holder. A same mirror holder may therefore be used for different vehicles.

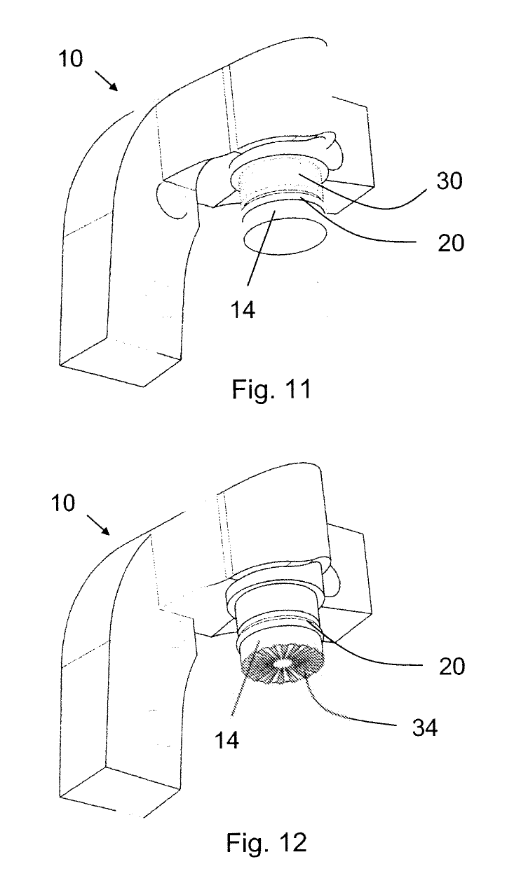

FIG. 11 shows as the first connection component a mirror base 10 having an annular protrusion and a locking geometry attached to the outer jacket surface 18. As the connection component is produced as an injection-molded or die-cast plastic component, the favorable shape including the elements of the bolt 14 with the outer jacket surface 18 that are necessary for the realization and an annular projection 20 as an engagement element may be produced without additional complexity. As an alternative for the locking geometry on the outer jacket surface 18, the latter may also be provided, in accordance with the representation in FIG. 12, at the end face 34 of the bolt portion 14 that cooperates with a corresponding locking surface on the sleeve bottom 36 (see FIG. 2) of the mirror-side holder 12.

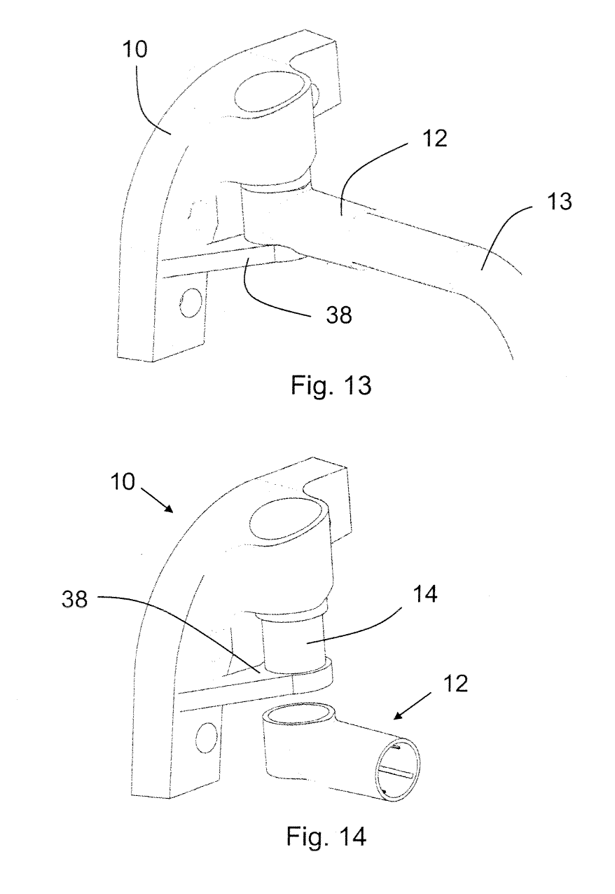

With regard to the vibration properties it is crucial how rigid the mirror holder is made. Depending on the geometrical relations—distance of the holders 4, 6 from each other and of the mirror head from the rotation axis—as well as the rigidity of the further supporting structure—for example the support pipe 13 or the mirror head—it is important for the bolt 14 to possess a rigid position. Where sufficient freedom of design and structural space exist for the vehicle-side connection component 10, a second coupling of the bolt to the base body of the connection component 10 may also be established. This may be achieved by means of a transverse web 38 at the end of the bolt portion 14. Correspondingly, the sleeve 16 includes a through bore in this embodiment. An engagement element or holding member on the jacket surfaces 18 or 24 is furthermore not necessary any more for securing the position, because this function is already served by the transverse web 38. FIGS. 13 and 14 show a corresponding solution by way of example.

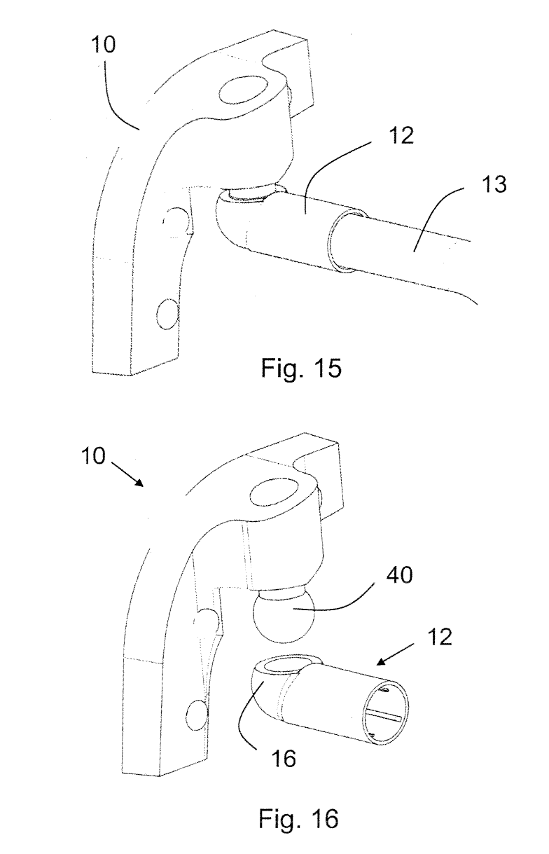

Another embodiment of the invention is shown in FIG. 15. If a spherical head 40 is provided at the end of the bolt portion 18 it also ensures the retaining function. In this case another advantage may be achieved in the form of further flexibility in the utilization of the same mirror holder for different applications. Comparably with the random rotational mounting of the support pipe 14 inside a pipe sleeve 12, as is shown in FIG. 9, the position of support structure and mirror head relative to the mirror holder may be changed while maintaining the rotational function about the rotation axis A. The lower flexibility as compared with the other solution has a restricting effect, however following assembly of the support structure (support pipe and/or head) it is still possible to change the position of the mirror relative to the mirror base, while the exploitation of the random pipe position in the locking sleeve by way of mounting relative to the longitudinal rotational axis B once and for all fixes the relative position of mirror and mirror base.

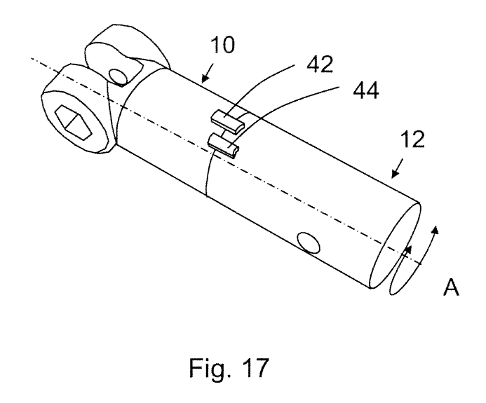

As the rotary connection of the invention fundamentally admits a rotation through 360° of the two connection components 10 and 12, on condition of overcoming the necessary fold-in force or locking/frictional forces, there is a possibility of providing in appropriate portions of the two connection components—with the exception of the jacket surfaces 18 and 24—one or more respective interacting catches 42 and 44 in order to limit the rotational range of the rotary connection. One example of such catches is shown in FIG. 17.

In the preceding description the mirror holder of the invention has been described with reference to particular embodiments. The mirror holder defined in the claims is, however, not limited to these embodiments. In particular it is also possible to combine the features of the individual embodiments among each other.

If the mirror holder of the invention is made of two injection-molded plastic parts, these may be realized so as to directly represent the outer surfaces of the mirror holder that will be visible later on. This has the advantage that they may be recycled in a plastic-specific manner without any disassembling effort. On the other hand, however, it is conceivable to provide them with covers with the aim of achieving more freedoms with regard to the configuration of the components.

Furthermore, the mirror holder of the invention has been described with reference to various kinds of utility vehicle mirrors. The fundamental principle of the mirror holder may, however, be transferred to the field of cars and motorcycles.

Starting out from the solution as shown in FIG. 10, it is also possible to employ a like mirror holder for a mirror system comprising only one holder, as is typical in ramp and front mirrors. The demanded adjustability of the mirror head is thus realized in a most simple manner by using a low-cost mirror holder.

### List of Reference Numerals

2 mirror assembly
4 upper mirror holder
6 lower mirror holder
8 mirror housing
10 vehicle-side holder (first connection component)
12 mirror-side holder (second connection component)
13 support pipe
14 bolt
16 sleeve
18 outer jacket surface
20 projection
22 groove
24 inner jacket surface
26 fastening portion
28 bore
30 (first) locking surfaces
32 (second) locking surfaces
34 end face
36 sleeve bottom
38 transverse web
40 spherical head
42 stop
44 stop
A rotation axis
B longitudinal axis
D wall thickness
d wall thickness

1. A mirror holder for automotive vehicle mirrors, comprising first and second connection components connected to each other so as to be rotatable about a rotation axis (A), wherein the first connection component comprises a bolt having a rotationally symmetrical jacket surface along the rotation axis (A), wherein the second connection component comprises a sleeve encircling the bolt and having an inner jacket surface shaped complementarily with the rotationally symmetrical jacket surface, and wherein the bolt or the sleeve comprises at least one engagement element which is engaged in a complementarily shaped retaining member in the sleeve or the bolt and blocks a displacement of the two connection components in the direction of the rotation axis (A).

2. The mirror holder according to claim 1, characterized in that sleeve and bolt have complementarily shaped first and second locking surfaces.

3. The mirror holder according to claim 2, characterized in that the two locking surfaces are formed on the jacket surfaces of bolt and sleeve.

4. The mirror holder according to claim 2, characterized in that the two locking surfaces are formed on the end face of the bolt and on the bottom of the sleeve.

5. The mirror holder according to any one of the claim 1, characterized in that the rotation axis (A) is formed transversely to the longitudinal axis (B) from the first and/or second connection component.

6. The mirror holder according to claim 1, characterized in that at least the sleeve of the second connection component is an injection-molded part and consists of a first plastic material.

7. The mirror holder according to claim 6, characterized in that at least the bolt of the first connection component is an injection-molded part and consists of a second plastic material, and in that the first plastic material has a lower melting point than the second plastic material.

8. The mirror holder according to claim 6, characterized in that the bolt is an injection-molded part and consists of a second plastic material, and in that the first plastic material and the second plastic material are plastic materials that are not compatible with each other.

9. The mirror holder according to claim 1, characterized in that the retaining member is a continuous groove in the jacket surface of bolt or sleeve.

10. The mirror holder according to claim 9, characterized in that the engagement element is a continuous protrusion engaging in the groove.

11. The mirror holder according to claim 10, characterized in that the groove and the protrusion are formed at the end of the respective jacket surface.

12. The mirror holder according to claim 11, characterized in that the first and second locking surfaces are provided in the groove or on the protrusion, respectively.

13. The mirror holder according to claim 1, characterized in that the first connection component comprises instead of the bolt a spherical portion which is encircled by a complementarily shaped portion of the second connection component.

14. The mirror holder according to claim 1, characterized in that one of the two connection components is a mirror base for mounting of the mirror on a vehicle, and the other one is a mirror arm or mirror arm part.

15. The mirror holder according to claim 1, characterized in that the mirror holder is manufactured by an in-mold assembly process.

16. The mirror holder according to claim 15, characterized in that during the manufacture of the second connection component, the molten plastic material does not enter into a solid connection with the plastic material of the first connection component.

17. The mirror holder according to claim 16, characterized in that following completion of the manufacturing process of the second connection component, permanent pressing is exerted on the bolt by the sleeve due to solidification of the plastic material.

18. The mirror holder according to claim 1, characterized in that both connection components are connected to each other in a non-releasable manner.

19. The mirror holder according to claim 1, characterized in that the bolt and the sleeve are each formed integrally.

20. A mirror assembly according to claim 1, further comprising a mirror fastened to the mirror holder
